(19) United States
(12) Patent Application Publication
(10) Pub. No.: US 2026/0200334 A1
(43) Pub. Date: Jul. 16, 2026

(54) OPTIMAL TRACKING CONTROL METHOD FOR PROTECTING TRANSIENT PERFORMANCE OF MAGLEV TRAIN

(71) Applicants: Tongji University, Shanghai (CN); Liaocheng University, Liaocheng City (CN)

(72) Inventors: Yougang SUN, Shanghai (CN); Wei SUN, Liaocheng City (CN); WEN Ji, Shanghai (CN); Junqi Xu, Shanghai (CN); Ning Jia, Shanghai (CN)

(21) Appl. No.: 19/202,652

(22) Filed: May 8, 2025

(30) Foreign Application Priority Data
Jan. 16, 2025 (CN) 202510072542.8

(51) Int. Cl. B60L 13/06; B60L 13/10

(52) U.S. Cl. CPC B60L 13/06; B60L 13/10; B60L 2200/26

(57) ABSTRACT

An optimal tracking control method for protecting transient performance of a maglev train is provided, relating to the technical field of maglev trains. The method includes: determining a dynamic magnetic suspension model based on a structure of a suspension frame; determining a maglev train model based on the dynamic magnetic suspension model; constructing a corresponding virtual controller based on the maglev train model; constructing a real controller based on the virtual controller; and controlling, by the real controller, a suspension air gap of a maglev vehicle. This application addresses the issues of inconsistent suspension gap output, high costs, and low resource utilization in existing maglev control technology.

### CROSS REFERENCE TO RELATED APPLICATION

This patent application claims the benefit and priority of Chinese Patent Application No. 2025100725428, filed with the China National Intellectual Property Administration on Jan. 16, 2025, the disclosure of which is incorporated by reference herein in its entirety as part of the present application.

### TECHNICAL FIELD

The present disclosure relates to the technical field of maglev trains, and in particular, to an optimal tracking control method for protecting transient performance of a maglev train.

### BACKGROUND

Currently, most medium and low-speed maglev trains utilize a four-suspension structure. Each suspension frame is independently controlled by four suspension controllers. However, each suspension point operates independently, and factors such as uneven load distribution within the train and random track irregularities can lead to inconsistent output of the suspension gap, and even cause overall suspension resonance, affecting passenger comfort. Therefore, designing a control algorithm that improves the transient performance of maglev trains is particularly important. Additionally, in real-world environments, maglev trains inevitably face various random disturbances, which can reduce normal operation of the maglev trains. To mitigate the impact of disturbances, control methods with robustness against disturbances are worth further exploration. Furthermore, with the rapid scientific and technological development nowadays, resource waste and energy consumption are pressing issues that need to be addressed in the development process. Designing a control algorithm that improves resource utilization has attracted widespread attention from researchers both domestically and internationally. In cases of resource scarcity or limitations, traditional adaptive backstepping control strategies are no longer applicable. Moreover, excessive resource waste can lead to high costs.

### SUMMARY

To overcome the shortcomings of the prior art, an objective of the present disclosure is to provide an optimal tracking control method for protecting transient performance of a maglev train. The present disclosure addresses the issues of inconsistent suspension gap output, high costs, and low resource utilization in existing maglev control technologies.

To achieve the above objective, the present disclosure provides the following technical solutions:

An optimal tracking control method for protecting transient performance of a maglev train is provided, including:
determining a dynamic magnetic suspension model based on a structure of a suspension frame;
determining a maglev train model based on the dynamic magnetic suspension model;
constructing a corresponding virtual controller based on the maglev train model;
constructing a real controller based on the virtual controller; and
controlling, by the real controller, a suspension air gap of a maglev vehicle.

Preferably, an expression for the dynamic magnetic suspension model is as follows:

$$\{ \begin{matrix}m ( t ) \ddot{z} ( t ) = m ( t ) g + {f}_{d} - F ( i , c ) , \\ u ( t ) = Ri ( t ) - \frac{{μ}_{0} {N}^{2} Ai ( t )}{2 {c}^{2} ( t )} \frac{d c ( t )}{dt} + \frac{{μ}_{0} {N}^{2} A}{2 {c}^{2} ( t )} \frac{di ( t )}{dt} , \\ F ( i ( t ) , c ( t ) ) = {\frac{{μ}_{0} {N}^{2} A}{4} [ \frac{i ( t )}{c ( t )} ]}^{2} , \\ z ( t ) = h ( t ) + c ( t ) ,\end{matrix} ;$$

where m represents a mass of a suspension body, g is a gravitational acceleration, z(t) represents a distance between a magnetic pole surface and a reference surface, h(t) indicates track irregularity, μ₀=4π×10⁻⁷ H/m represents permeability of air, A is an area of a magnetic core pole, c(t) indicates an air gap between a magnetic pole and a rail, N represents the number of turns in an electromagnet winding, i(t) represents a control coil current, F (i, c) is a controllable electromagnetic force, f_{d} represents external disturbances, R represents resistance, and t represents time.

Preferably, an expression for the maglev train model is as follows:

$$\{ \begin{matrix}{\dot{X}}_{1} = {X}_{2} , \\ {\dot{X}}_{2} = - \tilde{n} u + g + d\end{matrix} ,$$

where ñ is a control gain, g is a control input, d represents a disturbance, and x₁ represents a system output. \dot{x}₁ represents a first derivative of x₁ with respect to time t. x₂ represents a system state, and \dot{x}₂ represents a first derivative of x₂ with respect to time t.

Preferably, said constructing the corresponding virtual controller based on the maglev train model includes:
determining a boundary constraint of a transient performance constraint function of the maglev train model, where the boundary constraint includes an upper boundary function and a lower boundary function;
determining error mapping of the maglev train model according to the boundary constraint; and

constructing the corresponding virtual controller based on the error mapping.

Preferably, an expression for the upper boundary function is as follows:

$$\overline{b} = sign ( e ( 0 ) ) ( κ - {κ}_{∞} ) + {μ}_{1} κ ;$$

where e(0) is an initial value of a tracking error; κ_{∞}, μ₁, μ₂ are a first design parameter, a second design parameter, and a third design parameter, respectively; sign(·) is a sign function; and κ is a constrained piecewise function defined as follows:

$$κ = \{ \begin{matrix}csch ( {κ}_{0} + \frac{nt}{{T}_{0} - t} ) + {κ}_{∞} , 0 \leq t < {T}_{0} , \\ {κ}_{∞} , t \geq {T}_{0} ,\end{matrix}$$

where n represents a convergence rate of an output error, and κ₀ is an initial value of a preset boundary.

Preferably, an expression for the lower boundary function is as follows:

$$\underline{b} = sign ( e ( 0 ) ) ( κ - {κ}_{∞} ) + {μ}_{2} κ .$$

Preferable, an expression for the virtual controller is as follows:

$${\hat{ϑ}}_{1} = - \frac{1}{2 {σ}_{1}} [ 2 {ρ}_{1} {Ϛ}_{1} - 2 {σ}_{1} {\dot{r}}_{d} + 2 {σ}_{2} + {\hat{Γ}}_{a 1} {ψ}_{1} ] ;$$

where ρ₁ is a parameter to be designed; \hat{ϑ}₁ is the virtual controller; \dot{r}_{d} is a first derivative of a reference signal; ζ₁ represents a transformed error; Ψ₁ represents a fuzzy basis function; \hat{Γ}_{∂1} represents an estimate of a first Actor weight; σ₁, σ₂ represent a first function and a second function obtained by differentiating the error ζ₁; and T represents the transpose of a matrix.

Preferably, said constructing the real controller based on the virtual controller includes:
constructing a performance index function related to an error and the real controller;
obtaining a Hamilton-Jacobi-Bellman (HJB) equation based on the performance index function related to the error and the real controller;
based on a reinforcement learning strategy, obtaining a virtual controller equation of an Actor—Critic structure according to a fuzzy logic system and the virtual controller; and
obtaining an optimal real controller based on the virtual controller equation of the Actor—Critic structure and the HJB equation.

Preferably, an expression for an optimal real controller is as follows:

$$\hat{u} = - \frac{1}{2 \tilde{n}} [ 2 {ρ}_{2} {Ϛ}_{2} - 2 {\dot{\overline{ϑ}}}_{2} + 2 g + 2 \hat{δ} tanh ( \frac{{Ϛ}_{2}}{O} ) + {\hat{Γ}}_{a 2} {ψ}_{2} ] ;$$

where û is the optimal real controller; o is a positive constant; ζ₂ represents a transformed error related to state x₂; Ψ₂ represents a fuzzy basis function; and \hat{Γ}ₐ₂ represents an estimate of a second Actor weight. \dot{ϑ̅} represents an output of a filter. \hat{δ}represents an adaptive parameter; ρ₂ represents a control gain, and is an adjustable parameter. T T represents the transpose of a matrix.

The present disclosure achieves the following technical effects:

The present disclosure provides an optimal tracking control method for protecting transient performance of a maglev train, which includes: determining a dynamic magnetic suspension model based on a structure of a suspension frame; determining a maglev train model based on the dynamic magnetic suspension model; constructing a corresponding virtual controller based on the maglev train model; constructing a real controller based on the virtual controller; and controlling, by the real controller, a suspension air gap of a maglev vehicle. For the mathematical model of the maglev train system, the present disclosure designs an adaptive transient performance constraint optimal controller that keeps the suspension air gap of the maglev vehicle within a safe range while minimizing communication overhead and improving resource utilization, allowing the maglev train to track the target trajectory within a certain time and ensure tracking stability. First, based on the maglev train model, precise modeling is performed to obtain a system that better fits reality. Second, using the reinforcement learning strategy and Lyapunov stability theory, along with dynamic surface technology, approximation techniques of the fuzzy logic system, and scaling methods of Young's inequality, the transient performance boundary constraint function and adaptive transient performance constraint optimal controller are designed for the considered system. The designed controller can successfully achieve safe control even when the system is under disturbances and constraints, while saving communication resources and minimize communication overhead. The designed optimal control algorithm for transient performance constraints ensures that the trajectory tracking error of the maglev train is constrained within a predetermined range and guarantees tracking stability. The simplified structure of the maglev system can reduce operational costs. Meanwhile, the optimal control algorithm based on the reinforcement learning strategy can improve the operational efficiency of the system, achieving desired tracking control objectives at minimal cost. This has significant practical application value for enhancing the control performance of maglev trains.

### BRIEF DESCRIPTION OF THE DRAWINGS

To describe the technical solutions in embodiments of the present disclosure or in the prior art more clearly, the accompanying drawings required in the embodiments are briefly described below. Apparently, the accompanying drawings in the following description show merely some embodiments of the present disclosure, and other drawings can still be derived from these accompanying drawings by those of ordinary skill in the art without creative efforts.

FIG. 1 is a schematic flowchart of an optimal tracking control method for protecting transient performance of a maglev train according to an embodiment of the present disclosure; and

FIG. 2 is a schematic diagram of a strategy of an optimal tracking control method for protecting transient performance of a maglev train according to an embodiment of the present disclosure.

### DETAILED DESCRIPTION OF THE EMBODIMENTS

The technical solutions of the embodiments of the present disclosure are clearly and completely described below with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

To make the above objectives, features, and advantages of the present disclosure clearer and more comprehensible, the present disclosure will be further described in detail below with reference to the accompanying drawings and the specific examples.

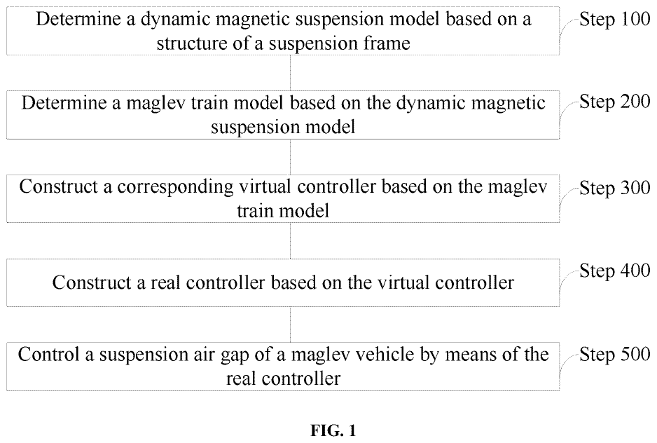

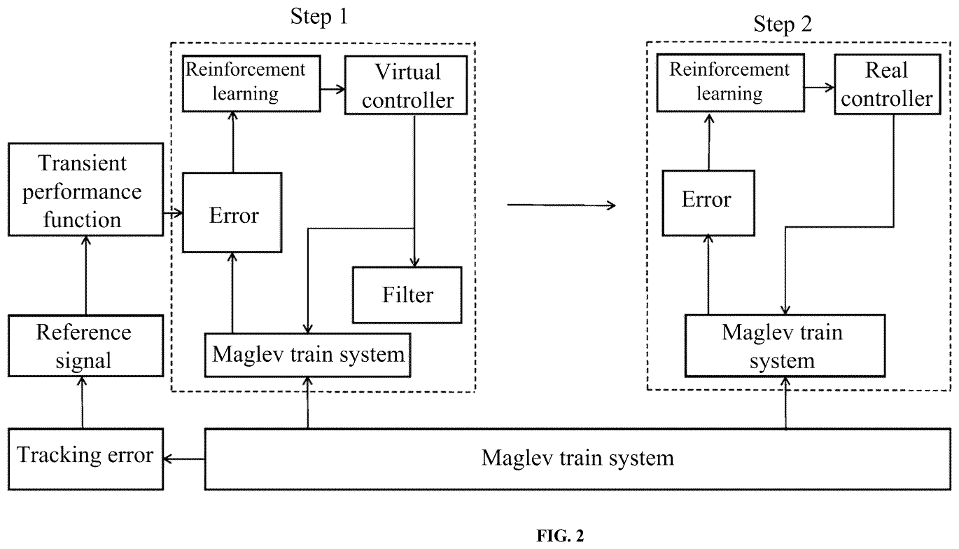

As shown in FIG. 1 and FIG. 2, the present disclosure provides an optimal tracking control method for protecting transient performance of a maglev train, which includes the following steps:

Step 100: Determine a dynamic magnetic suspension model based on a structure of a suspension frame.

Step 200: Determine a maglev train model based on the dynamic magnetic suspension model.

Step 300: Construct a corresponding virtual controller based on the maglev train model.

Step 400: Construct a real controller based on the virtual controller.

Step 500: Control a suspension air gap of a maglev vehicle by using the real controller.

Further, regarding the decoupling property of the suspension frame structure, the design of the suspension controller can be simplified to a single electromagnet suspension problem within a specific range. Ignoring magnetic leakage and rail magnetic resistance, considering the magnetic core, an effective air gap magnetic resistance R_{T} can be expressed as:

$${R}_{T} = \frac{2 c ( t )}{{μ}_{0} A} ,$$

where μ₀=4π×10⁻⁷ H/m represents permeability of air, A is an area of a magnetic core pole, and c(t) represents an air gap between a magnetic pole and a rail. An inductance of an electromagnet winding is given by:

$$L ( c , i ) = \frac{Ψ}{i ( t )} = \frac{N {Φ}_{T}}{i ( t )} = \frac{N}{i ( t )} \times \frac{Ni ( t )}{{R}_{T}} = \frac{{μ}_{0} {N}^{2} A}{2 c ( t )} ,$$

where L represents the inductance, Ψ is magnetic flux, N represents the number of turns in the electromagnet winding, and i(t) represents a control coil current. Then, an air gap magnetic flux density is defined as:

$$B = \frac{{Φ}_{m}}{A} \approx \frac{{Φ}_{T}}{A} = \frac{{μ}_{0} Ni ( t )}{2 c ( t )} ,$$

where B represents the air gap magnetic flux density, Φₘ is total magnetic flux, and Φ_{T} represents main magnetic flux. Energy stored in the magnetic field is as follows:

$$W ( i , c ) = \int Ψ ( i , c ) di = \int \frac{{μ}_{0} {N}^{2} Ai ( t )}{2 c ( t )} di = \frac{{μ}_{0} {N}^{2} {Ai}^{2} ( t )}{4 c ( t )} ,$$

where W represents the energy stored in the magnetic field. A controllable electromagnetic force F (i, c) is given by:

$$F ( i , c ) = \frac{\partial W ( i , c )}{\partial c} = {\frac{{μ}_{0} {N}^{2} A}{4} [ \frac{i ( t )}{c ( t )} ]}^{2} ,$$

A voltage equation of an electromagnet winding circuit can be obtained as follows:

$$u ( t ) = Ri ( t ) + \frac{Ψ}{t} = Ri ( t ) - \frac{{μ}_{0} {N}^{2} Ai ( t )}{2 {c}^{2} ( t )} \frac{dc ( t )}{dt} + \frac{{μ}_{0} {N}^{2} A}{2 {c}^{2} ( t )} \frac{di ( t )}{dt} ,$$

where u(t) represents a voltage of the electromagnet winding.

Based on the vertical force situation of the electromagnet, equations of the suspension system can be derived. f_{d} represents external disturbances. Considering the irregular variations of the track surface, z(t)=h(t)+c(t) In summary, the dynamic model can be obtained as follows:

$$\{ \begin{matrix}m ( t ) z ( t ) = m ( t ) g + {f}_{d} - F ( i , c ) , \\ u ( t ) = Ri ( t ) - \frac{{μ}_{0} {N}^{2} Ai ( t )}{2 {c}^{2} ( t )} \frac{dc ( t )}{dt} + \frac{{μ}_{0} {N}^{2} A}{2 {c}^{2} ( t )} \frac{di ( t )}{dt} , \\ F ( i ( t ) , c ( t ) ) = {\frac{{μ}_{0} {N}^{2} A}{4} [ \frac{i ( t )}{c ( t )} ]}^{2} , \\ z ( t ) - h ( t ) + c ( t ) ,\end{matrix} ;$$

where m represents a mass of a suspension body, g is a gravitational acceleration, z(t) represents a distance between a magnetic pole surface and a reference surface, h(t) indicates track irregularity, μ₀=4π×10⁻⁷ H/m represents permeability of air, A is an area of a magnetic core pole, c(t) indicates an air gap between a magnetic pole and a rail, N represents the number of turns in an electromagnet winding, i(t) represents a control coil current, F(i, c) is a controllable electromagnetic force, f_{d} represents external disturbances, R represents resistance, and t represents time.

Specifically, an expression for the maglev train model is as follows:

$$\{ \begin{matrix}{\dot{x}}_{1} = {x}_{2} , \\ {\dot{x}}_{2} = - \tilde{n} u + g + d ,\end{matrix}$$

where ñ is a control gain, g is a control input, d represents a disturbance, and x₁ represents a system output. \dot{x}₁ represents a first derivative of x₁ with respect to time. x₂ represents a system state, and \dot{x}₂ represents a first derivative of x₂ with respect to time.

$$\tilde{n} = \frac{{μ}_{0} {N}^{2} A}{4 m} , u = {[ \frac{i ( t )}{{x}_{1} - h ( t )} ]}^{2} , d = \frac{{f}_{d} ( t )}{m} .$$

Further, said constructing the corresponding virtual controller based on the maglev train model includes:
determining a constraint boundary of a transient performance constraint function of the maglev train model, where the constraint boundary includes an upper boundary function and a lower boundary function;
determining error mapping of the maglev train model according to the constraint boundary; and

constructing the corresponding virtual controller based on the error mapping.

Specifically, constraint boundaries of a transient performance constraint scale function are defined. The continuous constraint boundary functions b̅,b satisfy the following conditions: both b̅ and b are increasing functions, and for T₀>0 [0,T₀] is strictly increasing.

For T₀>0 b̅(t)>b(t);
where T₀ is a residence time. Based on the properties of the hyperbolic secant function, a pair of feasible boundary functions t├→(b̅, b) are provided as follows:
An expression for the upper boundary function is as follows:

$$\overline{b} = sign ( e ( 0 ) ) ( κ - {κ}_{∞} ) + {μ}_{1} κ ;$$

where e(0) is an initial value of a tracking error; κ_{∞}, μ₁, μ₂ are a first design parameter, a second design parameter, and a third design parameter, respectively; sign(·) is a sign function; and κ is a constrained piecewise function defined as follows:

$$κ = \{ \begin{matrix}csch ( {κ}_{0} + \frac{nt}{{T}_{0} - t} ) + {κ}_{∞} \cdot 0 \leq t < {T}_{0} , \\ {κ}_{∞} , t \geq {T}_{0} ,\end{matrix}$$

where n represents a convergence rate of an output error, and κ₀ is an initial value of a preset boundary.

An expression for the lower boundary function is as follows:

$$\underline{b} = sign ( e ( 0 ) ) ( κ - {κ}_{∞} ) + {μ}_{2} κ .$$

where e(0) is an initial value of a tracking error, κ_{∞}, μ₁, μ₂ are designed parameters, sign(·) is a sign function, and:

$$κ = \{ \begin{matrix}csch ( {κ}_{0} + \frac{nt}{{T}_{0} - t} ) + {κ}_{∞} \cdot 0 \leq t < {T}_{0} , \\ {κ}_{∞} , t \geq {T}_{0} ,\end{matrix}$$

where n represents a convergence rate of an output error, and κ₀ is an initial value of a preset boundary.

A fuzzy logic system for approximating nonlinear functions is defined. The fuzzy logic system consists of a fuzzy rule base, as well as fuzzification and defuzzification operators. The fuzzy rule base consists of inference rules. The inference rules R^{j} are defined as follows: If x₁ is

$${A}_{1}^{j} , {x}_{2} is {A}_{2}^{j} … {x}_{n} is {A}_{n}^{j} ,$$

then y is B^{j},i=1, . . . , m, where x=[x₁,x₂, . . . , xₙ]ϵRⁿ and y ϵR are inputs outputs of the fuzzy logic system;

$${A}_{1}^{j} , {A}_{2}^{j} , … , {A}_{n}^{j}$$

and B^{j} are fuzzy sets in the real number domain. Based on the theory of the fuzzy logic system, the output of the fuzzy system is represented as:

$$y ( x ) = \frac{{\sum }_{j = 1}^{m} {y}_{j} {\prod }_{i = 1}^{n} {v}_{{A}_{i}^{j}} ( {x}_{i} )}{{\sum }_{j = 1}^{m} [ {\prod }_{i = 1}^{n} {v}_{{A}_{i}^{j}} ( {x}_{i} ) ]} ,$$

where y̅ⱼϵR is the point

$${v}_{{B}_{i}^{j}} ( \cdot )$$

that maximizes the function. By letting

$${ψ}^{j} = \frac{{\prod }_{i = 1}^{n} {v}_{{A}_{i}^{j}} ( {x}_{i} )}{{\sum }_{j = 1}^{m} [ {\prod }_{i = 1}^{n} {v}_{{A}_{i}^{j}} ( {x}_{i} ) ]} , ψ = {[ {ψ}^{1} , {ψ}^{2} , … , {ψ}^{m} ]}^{T} ,$$

and Γ[y̅₁, y̅₂, . . . , y̅ₘ]^{T}=[Γ₁, Γ₂, . . . , Γₘ]^{T}, it is obtained that:

$$y ( x ) = {Γ}^{T} ψ + ε .$$

The error mapping of the maglev train system is defined.

$$\{ \begin{matrix}{Ϛ}_{1} = ln ( \frac{ϕ}{1 - ϕ} ) , \\ {Ϛ}_{2} = {x}_{2} - {\overline{ϑ}}_{2} ,\end{matrix}$$

A first-order low-pass filter is designed as follows:

$$r {\dot{\overline{ϑ}}}_{2} + {\overline{ϑ}}_{2} = {ϑ}_{1} , {\overline{ϑ}}_{2} ( 0 ) = {ϑ}_{1} ( 0 ) , ℓ = {\overline{ϑ}}_{2} - {ϑ}_{1} ,$$

where ϑ₁ is an input to the filter, [symbol] is a filtering error, and ϑ̅₂ is an output of the filter.

Then, the derivative of the error is solved:

$$\{ \begin{matrix}{\dot{Ϛ}}_{1} = {σ}_{1} ( {\dot{x}}_{1} - {\dot{r}}_{d} ) + {σ}_{2} , \\ {\dot{Ϛ}}_{2} = {\dot{x}}_{2} - {\dot{\overline{ϑ}}}_{2} ,\end{matrix}$$

where,

$${σ}_{1} = \frac{1}{ϕ \{ 1 - ϕ ) Δ b} , {σ}_{2} = \frac{{σ}_{1}}{Δ b} [ \underline{b} \dot{\overline{b}} - \dot{\underline{b}} \overline{b} - e \dot{Δ} b ] , \underline{\dot{b}} = [ sign ( e ( 0 ) - {μ}_{2} ) ] \dot{κ} , \dot{\overline{b}} = [ sign ( e ( 0 ) - {μ}_{1} ) ] \dot{κ} , ϕ = \frac{1}{Δ b} ( e - \underline{b} ) ,$$

Δb=b̅−b is a constant, and r′_{d} is a first derivative of the reference signal.

Using the definitions of the error mapping and filtering, it is obtained that:

$$\{ \begin{matrix}{\dot{Ϛ}}_{1} = {σ}_{1} ( {Ϛ}_{2} + ℓ + {ϑ}_{1} + {\dot{r}}_{d} ) + {σ}_{2} , \\ {\dot{Ϛ}}_{2} = - \tilde{n} u + g + d -- {\dot{\overline{ϑ}}}_{2} ,\end{matrix}$$

Subsequently, the virtual controller is constructed. In the design process of the controller, a candidate Lyapunov function is selected at each step to construct the virtual controller until the final step of constructing the real controller.

Furthermore, an expression for the virtual controller is as follows:

$${\hat{ϑ}}_{1} = - \frac{1}{2 {σ}_{1}} [ 2 {ρ}_{1} {Ϛ}_{1} - 2 {σ}_{1} {\dot{r}}_{d} + 2 {σ}_{2} + {\hat{Γ}}_{a 1}^{T} {ψ}_{1} ] ;$$

where ρ₁ is a parameter to be designed; \hat{ϑ}₁ is the virtual controller; r′_{d} is a first derivative of a reference signal; ζ₁ represents a transformed error; ψ₁ represents a fuzzy basis function; \hat{Γ}ₐ₁ represents an estimate of a first Actor weight; σ₁,σ₂ represent a first function and a second function obtained by differentiating the error ζ₁; and T represents the transpose of a matrix.

At the same time, an actor-critic weight update rate \hat{Γ}ₐⱼ, \hat{Γ}_{ci} (i=1,2) and an adaptive law \dot{\hat{δ}} are designed as follows:

$$\begin{matrix}{\dot{\hat{Γ}}}_{ai} = - {ψ}_{i} {ψ}_{i}^{T} [ {ϖ}_{ai} ( {\hat{Γ}}_{ai} - {\hat{Γ}}_{ci} ) + {ϖ}_{ci} {\hat{Γ}}_{ci} ] , \\ {\dot{\hat{Γ}}}_{ci} = - {ϖ}_{ci} {ψ}_{i} {φ}_{i}^{T} {\hat{Γ}}_{ci} , \\ \dot{\hat{δ}} = {τϚ}_{2} tanh ( \frac{{Ϛ}_{2}}{O} ) - τι \hat{δ} ,\end{matrix}$$

wher ω̅ₐᵢ, ω̅_{ci}, (i=1, 2) is a parameter to be designed.

Further, said constructing the real controller based on the virtual controller includes:
constructing a performance index function related to an error and the real controller;
obtaining a Hamilton-Jacobi-Bellman (HJB) equation based on the performance index function related to the error and the real controller;
based on a reinforcement learning strategy, obtaining a virtual controller equation of an Actor—Critic structure according to a fuzzy logic system and the virtual controller; and
obtaining an optimal real controller based on the virtual controller equation of the Actor—Critic structure and the HJB equation.

Further, an actual optimal controller is solved. The performance index function, also known as the value function, is related to the error and the controller:

$$\begin{matrix}{W}_{1}^{*} ( {Ϛ}_{1} ) = {min}_{{ϑ}_{1} ∈ Ψ ( Ω )} E [ {\int }_{t}^{∞} {h}_{1} ( {Ϛ}_{1} , {ϑ}_{1} ) d τ ] , \\ {W}_{2}^{*} ( {Ϛ}_{2} ) = {min}_{{ϑ}_{2} ∈ Ψ ( Ω )} E [ {\int }_{t}^{∞} {h}_{2} ( {Ϛ}_{2} , u ) d τ ] , \\ where {h}_{1} ( {Ϛ}_{1} , {ϑ}_{1} ) = {Ϛ}_{1}^{2} + {ϑ}_{1}^{2} and {h}_{2} ( {Ϛ}_{2} , u ) = {Ϛ}_{2}^{2} + {u}^{2}\end{matrix}$$

are cost functions. The HJB equation is the derivative of the performance index function with respect to time. Therefore, the HJB equation at each step is as follows:

$$\begin{matrix}{H}_{1} ( {Ϛ}_{1} , {ϑ}_{1}^{*} \frac{{dW}_{1}^{*}}{d {Ϛ}_{1}} ) = {Ϛ}_{1}^{2} + {ϑ}_{1}^{* 2} + ∇ {W}_{1}^{* T} [ {σ}_{1} ( {ϑ}_{1}^{*} - {\dot{r}}_{d} ) + {σ}_{2} ] = 0 , \\ {H}_{2} ( {Ϛ}_{2} , {u}^{*} \frac{{dW}_{2}^{*}}{d {Ϛ}_{2}} ) = {Ϛ}_{2}^{2} + {u}^{* 2} + ∇ {W}_{2}^{* T} [ - \tilde{n} u + g + d - {\dot{\overline{ϑ}}}_{2} ] = 0 , \\ where ∇ {W}_{i}^{*} = \frac{{dW}_{i}^{*}}{{dϚ}_{i}}\end{matrix}$$

is the gradient of

$${W}_{i}^{*}$$

related to ζᵢ.

First, the performance index function related to the error and the controller is constructed:

$${W}_{1}^{*} ( {Ϛ}_{1} ) = {min}_{{ϑ}_{1} ∈ ΨΩ )} E [ {\int }_{t}^{∞} {h}_{1} ( {Ϛ}_{1} , {ϑ}_{1} ) d τ ] = {\int }_{t}^{∞} {h}_{1} ( {Ϛ}_{1} , {ϑ}_{1}^{*} ) d τ ;$$

then, the derivative of the performance index function with respect to time t is taken, to obtain the HJB equation:

$${H}_{1} ( {Ϛ}_{1} , {ϑ}_{1}^{*} , \frac{{dW}_{1}^{*}}{d {Ϛ}_{1}} ) = {Ϛ}_{1}^{2} + {ϑ}_{1}^{* 2} + ∇ {W}_{1}^{* T} [ {σ}_{1}^{*} - {\dot{r}}_{d} ) + {σ}_{2} ] = 0.$$

Based on the equation

$$\partial {H}_{1}^{*} ( {Ϛ}_{1} , {ϑ}_{1}^{*} , \frac{{dW}_{1}^{*}}{{dϚ}_{1}} ) / \partial {ϑ}_{1}^{*} = 0 ,$$

the controller

$${ϑ}_{1}^{*} = - \frac{{σ}_{1}}{2} \frac{{dW}_{1}^{*}}{d {Ϛ}_{1}}$$

is obtained, where the gradient

$$\frac{{dW}_{1}^{*}}{d {Ϛ}_{1}}$$

is rewritten as

$$\frac{{dW}_{1}^{*}}{d {Ϛ}_{1}} = \frac{1}{{σ}_{1}^{2}} [ 2 {ρ}_{1} {Ϛ}_{1} - 2 {σ}_{1} {\dot{r}}_{d} + 2 {σ}_{2} + {W}_{1}^{0} ( {Ϛ}_{1} ) ] ,$$

and substituted into the controller:

$${ϑ}_{1}^{*} = \frac{1}{2 {σ}_{1}} [ 2 {ρ}_{1} {Ϛ}_{1} - 2 {σ}_{1} {\dot{r}}_{d} + 2 {σ}_{2} + {W}_{1}^{0} ( {Ϛ}_{1} ) ] .$$

Since

$${J}_{1}^{0}$$

is unknown, the fuzzy logic system is used for approximation to obtain:

$${W}_{1}^{0} = {Γ}_{1}^{T} {ψ}_{1} + {ε}_{1} ,$$

where Γ₁ is an ideal weight, ψ₁ is the fuzzy basis function, and ε₁ is a residual of the fuzzy logic system. To achieve optimal control based on the reinforcement learning strategy, the Actor—Critic structure is designed:

$$\begin{matrix}\frac{d \hat{W}}{d {Ϛ}_{1}} = \frac{1}{{σ}_{1}^{2}} [ 2 {ρ}_{1} {Ϛ}_{1} - 2 {σ}_{1} {\dot{r}}_{d} + 2 {σ}_{2} + {\hat{Γ}}_{c 1}^{T} {ψ}_{1} ] , \\ {\hat{ϑ}}_{1} = - \frac{1}{2 {σ}_{1}} [ 2 {ρ}_{1} {Ϛ}_{1} - 2 {σ}_{1} {\dot{r}}_{d} + 2 {σ}_{2} + {\hat{Γ}}_{a 1}^{T} {ψ}_{1} ] .\end{matrix}$$

Substitution into the HJB equation gives

$${\hat{H}}_{1} ( {Ϛ}_{1} , {\hat{ϑ}}_{1} , \frac{d \hat{W}}{d {Ϛ}_{1}} ) ,$$

and then

$${\tilde{H}}_{1} ( {Ϛ}_{1} , {ϑ}_{1} , \frac{{dW}_{1}}{{d}_{{Ϛ}_{1}}} )$$

is as follows:

$${\tilde{H}}_{1} ( {Ϛ}_{1} , {ϑ}_{1} , \frac{{dW}_{1}}{{d}_{{Ϛ}_{1}}} ) = {H}_{1} ( {Ϛ}_{1} , {ϑ}_{1}^{*} , \frac{{dW}_{1}^{*}}{{d}_{{Ϛ}_{1}}} ) - {\hat{H}}_{1} ( {Ϛ}_{1} , {ϑ}_{1} , \frac{d \hat{W}}{{d}_{{Ϛ}_{1}}} ) = - {\hat{H}}_{1} ( {Ϛ}_{1} , {\hat{ϑ}}_{1} , \frac{d \hat{W}}{{d}_{{Ϛ}_{1}}} ) = - {\hat{H}}_{1} ( {Ϛ}_{1} , {\hat{ϑ}}_{1} , \frac{d \hat{W}}{{d}_{{Ϛ}_{1}}} ) .$$

Then, for the optimal control design, the optimal virtual controller \hat{ϑ}₁ is required to satisfy the approximation function of the HJB equation:

$${\hat{H}}_{1} ( {Ϛ}_{1} , {\hat{ϑ}}_{1} , \frac{d {\hat{W}}_{1}}{{d}_{{Ϛ}_{1}}} ) \to 0 ;$$

if the optimal virtual controller \hat{ϑ}₁ is the unique solution of

$${\tilde{H}}_{1} ( {Ϛ}_{1} , {ϑ}_{1} , \frac{{dW}_{1}}{{d}_{{Ϛ}_{1}}} ) = 0 ,$$

then it needs to satisfy the following condition:

$$\frac{\partial {\hat{H}}_{1} ( {Ϛ}_{1} , {\hat{ϑ}}_{1} , \frac{d {\hat{W}}_{1}}{{d}_{{Ϛ}_{1}}} )}{\partial {\hat{Γ}}_{a 1}} = \frac{1}{2 {σ}_{1}} {ψ}_{1} {ψ}_{1}^{T} ( {\hat{Γ}}_{a 1} - {\hat{Γ}}_{c 1} ) = 0.$$

According to the fuzzy logic system

$$0 < {ψ}_{1} {ψ}_{1}^{T} < 1 ,$$

by designing the weight update law to ensure that

$${\hat{H}}_{1} ( {Ϛ}_{1} , {\hat{ϑ}}_{1} , \frac{d \hat{W}}{{d}_{{Ϛ}_{1}}} ) \to 0 ,$$

thereby achieving the reinforcement learning strategy and successfully obtaining the actual optimal controller. The actual optimal controller is as follows:

$$\hat{u} = - \frac{1}{2 \tilde{n}} [ 2 {ρ}_{2} {Ϛ}_{2} - 2 {\dot{\overline{ϑ}}}_{2} + 2 g + 2 \hat{δ} tan h ( \frac{{Ϛ}_{2}}{o} ) + {\hat{Γ}}_{a 2} {ψ}_{2} ] ;$$

where ρ₂, o>0 is a designed positive constant, û is an optimal real controller, ζ₂ represents an error mapping result related to state x₂, ψ₂ represents the fuzzy basis function, \hat{Γ}ₐ₂ represents an estimate of a second Actor weight. \dot{ϑ̅}₂ represents an output of a filter. \hat{δ} represents an adaptive parameter, and T the transpose of a matrix.

Each embodiment in the description is described in a progressive mode, each embodiment focuses on differences from other embodiments, and references can be made to each other for the same and similar parts between embodiments.

Specific examples are used herein for illustration of the principles and embodiments of the present disclosure. The description of the foregoing embodiments is used to help understand the method of the present disclosure and the core principles thereof. In addition, those of ordinary skill in the art can make various modifications in terms of specific embodiments and scope of application in accordance with the teachings of the present disclosure. In conclusion, the content of the description shall not be construed as limitations to the present disclosure.

What is claimed is:

1. An optimal tracking control method for protecting transient performance of a maglev train, comprising:
determining a dynamic magnetic suspension model based on a structure of a suspension frame;
determining a maglev train model based on the dynamic magnetic suspension model;
constructing a corresponding virtual controller based on the maglev train model;
constructing a real controller based on the virtual controller; and
controlling, by the real controller, a suspension air gap of a maglev vehicle.

2. The optimal tracking control method for protecting transient performance of a maglev train according to claim 1, wherein an expression for the dynamic magnetic suspension model is as follows:
$$\{ \begin{matrix}m ( t ) z ( t ) = m ( t ) g + {f}_{d} - F ( i , c ) , \\ u ( t ) = Ri ( t ) - \frac{{μ}_{0} {N}^{2} Ai ( t )}{2 {c}^{2} ( t )} \frac{dc ( t )}{dt} + \frac{{μ}_{0} {N}^{2} A}{2 {c}^{2} ( t )} \frac{di ( t )}{dt} , \\ F ( i ( t ) , c ( t ) ) = {\frac{{μ}_{0} {N}^{2} A}{4} [ \frac{i ( t )}{c ( t )} ]}^{2} , \\ z ( t ) = h ( t ) + c ( t ) ,\end{matrix} ;$$
wherein m represents a mass of a suspension body, g is a gravitational acceleration, z(t) represents a distance between a magnetic pole surface and a reference surface, h(t) indicates track irregularity, μ₀=4π×10⁻⁷ H/m represents permeability of air, A is an area of a magnetic core pole, c(t) indicates an air gap between a magnetic pole and a rail, N represents the number of turns in an electromagnet winding, i(t) represents a control coil current, F (i,c) is a controllable electromagnetic force, f_{d} represents external disturbances, R represents resistance, and t represents time.

3. The optimal tracking control method for protecting transient performance of a maglev train according to claim 2, wherein an expression for the maglev train model is as follows:
$$\{ \begin{matrix}{\dot{x}}_{1} = {x}_{2} , \\ {\dot{x}}_{2} = - \tilde{n} u + g + d ,\end{matrix}$$
wherein ñ is a control gain, g is a control input, d represents a disturbance, and x₁ represents a system output, \dot{x}₁ represents a first derivative of x₁ with respect to time t, x₂ represents a system state, and \dot{x}₂ represents a first derivative of x₂ with respect to t.

4. The optimal tracking control method for protecting transient performance of a maglev train according to claim 3, wherein said constructing the corresponding virtual controller based on the maglev train model comprises:
determining a constraint boundary of a transient performance constraint function of the maglev train model, wherein the constraint boundary comprises an upper boundary function and a lower boundary function;
determining error mapping of the maglev train model according to the constraint boundary; and
constructing the corresponding virtual controller based on the error mapping.

5. The optimal tracking control method for protecting transient performance of a maglev train according to claim 4, wherein an expression for the upper boundary function is as follows:
$$\overline{b} = sign ( e ( 0 ) ) ( κ - {κ}_{∞} ) + {μ}_{1} κ ;$$
wherein e(0) is an initial value of a tracking error; κ_{∞}, μ₁, μ₂ are a first design parameter, a second design parameter, and a third design parameter, respectively; sign(·) is a sign function; and κ is a constrained piecewise function defined as follows:
$$κ = \{ \begin{matrix}csch ( {κ}_{0} + \frac{nt}{{T}_{0} - t} ) + {κ}_{∞} \text{.0} \leq t < {T}_{0} , \\ {κ}_{∞} . t \geq {T}_{0} ,\end{matrix}$$
wherein n represents a convergence rate of an output error, κ₀ is an initial value of a preset boundary, T₀ represents an adjustment time, and csch represents a hyperbolic secant function.

6. The optimal tracking control method for protecting transient performance of a maglev train according to claim 5, wherein an expression for the lower boundary function is as follows:
$$\underline{b} = sign ( e ( 0 ) ) ( κ - {κ}_{∞} ) + {μ}_{2} κ .$$

7. The optimal tracking control method for protecting transient performance of a maglev train according to claim 6, wherein an expression for the virtual controller is as follows:
$${\hat{ϑ}}_{1} = - \frac{1}{2 {σ}_{1}} [ 2 {ρ}_{1} {Ϛ}_{1} - 2 {σ}_{1} {r}_{d} + 2 {σ}_{2} + {Γ}_{a 1} {ψ}_{1} ] ;$$
wherein ρ₁ is a parameter to be designed; \hat{ϑ}₁ is the virtual controller; r′_{d} is a first derivative of a reference signal; ζ₁ represents an error mapping result; ψ₁ represents a fuzzy basis function; \hat{Γ}ₐ₁ represents an estimate of a first Actor weight; σ₁,σ₂ represent a first function and a second function obtained by differentiating the error ζ₁; and T represents the transpose of a matrix.

8. The optimal tracking control method for protecting transient performance of a maglev train according to claim 1, wherein said constructing the real controller based on the virtual controller comprises:
constructing a performance index function related to an error and the real controller;
obtaining a Hamilton-Jacobi-Bellman (HJB) equation based on the performance index function related to the error and the real controller;
based on a reinforcement learning strategy, obtaining a virtual controller equation of an Actor—Critic structure according to a fuzzy logic system and the virtual controller; and
obtaining an optimal real controller based on the virtual controller equation of the Actor—Critic structure and the HJB equation.

9. The optimal tracking control method for protecting transient performance of a maglev train according to claim 7, wherein an expression for an optimal real controller is as follows:
$$\hat{u} = - \frac{1}{2 \tilde{n}} [ 2 {ρ}_{2} {Ϛ}_{2} - 2 {\dot{\overline{ϑ}}}_{2} + 2 g + 2 \hat{δ} tan h ( \frac{{Ϛ}_{2}}{o} ) + {\hat{Γ}}_{a 2} {ψ}_{2} ] ;$$
wherein û is the optimal real controller; o is a positive constant; ζ₂ represents an error mapping result related to state x₂; ψ₂ represents a fuzzy basis function; \hat{Γ}ₐ₂ represents an estimate of a second Actor weight; \overline{\dot{ϑ}}₂ represents an output of a filter; \hat{δ}represents an adaptive parameter; ρ₂ represents a control gain, and is an adjustable parameter; and T represents the transpose of a matrix.
